(19) United States
(12) Patent Application Publication
(10) Pub. No.: US 2015/0215179 A1
(43) Pub. Date: Jul. 30, 2015

(54) Exchange of Throughput Profile Information for Supporting Coordinated Scheduling

(71) Applicant: NOKIA SOLUTIONS AND NETWORKS OY, Espoo (FI)

(72) Inventors: Bishwarup MONDAL, Beavercreek, OH (US); Sean KELLEY, Hoffman Estates, IL (US); Xiaoyi WANG, Wheeling, IL (US)

(73) Assignee: NOKIA SOLUTIONS AND NETWORKS OY, Espoo (FI)

(21) Appl. No.: 14/168,685

(22) Filed: Jan. 30, 2014

(51) Int. Cl. H04L 12/26; H04W 72/04; H04W 24/10

(52) U.S. Cl. CPC H04L 43/062; H04W 24/10; H04W 72/0426; H04W 72/0486

(57) ABSTRACT

Various communication systems may benefit from information related to coordinated scheduling. For example, certain base stations may benefit from exchange of throughput profile information. A method can include determining a throughput profile for a group of user equipment in a cell. The method can also include reporting the throughput profile to a neighbor cell or central node.

### BACKGROUND

1. Field

Various communication systems may benefit from information related to coordinated scheduling. For example, certain base stations may benefit from exchange of throughput profile information.

2. Description of the Related Art

A plethora of metrics may be possible, with respect to enhanced Coordinated Multi Point (eCOMP), for communicating from one evolved Node B (eNB) to another or to a centralized entity. Specifically, such metrics may be for the purposes of determining a coordinated muting pattern for each cell. These metrics, as conventionally envisioned, either involve a large amount of information exchange, such as user equipment (UE) reported channel state information (CSI), or are very specific to an implementation algorithm, such as proportional fair (PF) metrics or precoding matrix indicator (PMI) for coordinated beamforming.

A common aspect of the conventional ideas is trying to determine the muting pattern using information exchange. However, a standardized message should not conventionally be too tied to a specific algorithm.

One conventional option is scheduled internet protocol (IP) throughput for minimization of drive tests (MDT) in downlink (DL), as described at section 4.1.7.1 of 3GPP technical specification (TS) 36.314, the entirety of which is hereby incorporated herein by reference. This is a throughput measurement at the Packet Data Convergence Protocol (PDCP) layer that is performed per-UE or per-radio access bearer (RAB)/per-UE. This measurement is provided to the core network (CN) via S1 to mobility management entity (MME), or NBI to operations and maintenance (OAM), along with UE location information in order to, for example, generate throughput maps, similar to coverage maps.

Another approach is relative narrowband transmission (Tx) power, which is described at section 9.2.19 of 3GPP TS 36.423. This is a “power profile” that indicates relative narrowband transmit power (RNTP) per-physical resource block (PRB). This profile is provided to neighbor cells to indicate the sending cell's intention to limit Tx power in certain PRBs. This information can be taken into account by the neighbor cells, for example when scheduling cell edge UEs for inter-cell interference coordination (ICIC) in power and frequency domains.

In short, the signaling conventionally envisioned focuses on the information conditioned to one or more muting hypotheses. Such a message is designed to determine the muting pattern in an open loop manner.

### SUMMARY

According to certain embodiments, a method can include determining a throughput profile for a group of user equipment in a cell. The method can also include reporting the throughput profile to a neighbor cell or central node.

In certain embodiments, a method can include sending a request for a throughput profile from a first cell. The method can also include adapting a muting pattern of a second cell based on the throughput profile.

An apparatus, according to certain embodiments, can include at least one processor and at least one memory including computer program code. The at least memory and the computer program code can be configured to, with the at least one processor, cause the apparatus at least to determine a throughput profile for a group of user equipment in a cell. The at least memory and the computer program code can also be configured to, with the at least one processor, cause the apparatus at least to report the throughput profile to a neighbor cell or central node.

An apparatus, in certain embodiments, can include at least one processor and at least one memory including computer program code. The at least memory and the computer program code can be configured to, with the at least one processor, cause the apparatus at least to send a request for a throughput profile from a first cell. The at least memory and the computer program code can also be configured to, with the at least one processor, cause the apparatus at least to adapt a muting pattern of a second cell based on the throughput profile.

According to certain embodiments, an apparatus can include means for determining a throughput profile for a group of user equipment in a cell. The apparatus can also include means for reporting the throughput profile to a neighbor cell or central node.

In certain embodiments, an apparatus can include means for sending a request for a throughput profile from a first cell. The apparatus can also include means for adapting a muting pattern of a second cell based on the throughput profile.

A non-transitory computer-readable medium can, according to certain embodiments, be encoded with instructions that, when executed in hardware, perform a process. The process can include any of the above-identified methods.

A computer program produce can, according to certain embodiments, encode instructions for performing a process. The process can include any of the above-identified methods.

### BRIEF DESCRIPTION OF THE DRAWINGS

For proper understanding of the invention, reference should be made to the accompanying drawings, wherein:

FIG. 1 illustrates muting patterns and throughput profiles for cells A, B and C, according to certain embodiments.

FIG. 2 illustrates a signal flow diagram according to certain embodiments.

FIG. 3 illustrates a method according to certain embodiments.

FIG. 4 illustrates another method according to certain embodiments.

FIG. 5 illustrates a system according to certain embodiments.

### DETAILED DESCRIPTION

In certain embodiments, instead of trying to determine a muting pattern, information exchange can be used to reflect the results of using a muting pattern. Thus, certain embodiments may employ throughput information in a different way than conventionally envisioned.

The throughput profile can be measured from actual scheduled physical downlink shared channel (PDSCH) after the application of muting patterns, not under any hypothesis, and can be associated to a particular UE grouping in the cell.

By contrast to conventional approaches, the throughput profile determination in certain embodiments is not associated with any muting pattern, but instead is conditioned to a certain period of time and to a group of UEs.

Certain embodiments can relate to an inter-eNB coordinated interference management scheme in which access nodes exchange information in order to decide the behavior of eNBs. Certain embodiments, for example, define a throughput profile, as a function of PRB in frequency, for UEs in a particular cell. Moreover, in certain embodiments the eNBs signal this profile over an X2 interface to neighboring cells using an X2 message. Other interfaces and other messages are also permitted.

As mentioned above, the throughput profile can be conditioned on certain muting patterns that are applied for PDSCH transmission in the neighbor cells. Therefore, the profile can be used to adapt the muting patterns in a closed loop manner. The throughput metric, accordingly, can be used to enable a closed-loop type of muting pattern adaptation unlike other metrics under different conventional hypotheses, for determining a muting pattern, namely selecting among different muting patterns.

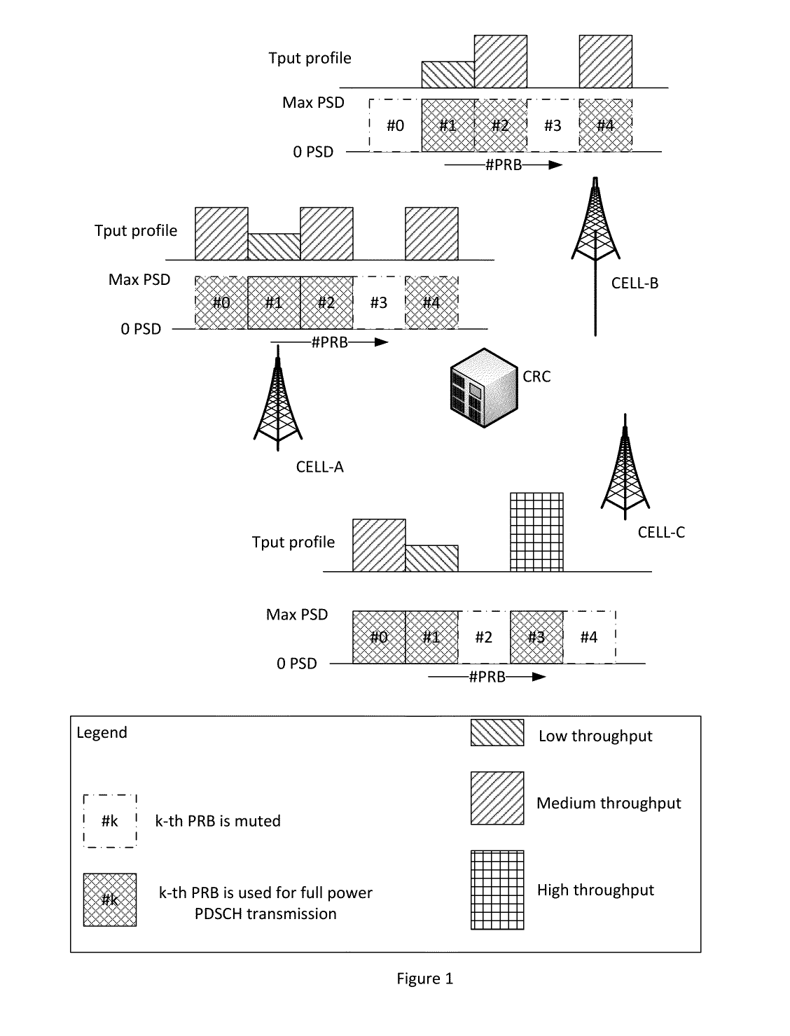

FIG. 1 illustrates muting patterns and throughput profiles for cells A, B and C, according to certain embodiments. More particularly, FIG. 1 illustrates a situation in which 3 cells—A, B and C—form a set of coordinating cells. The muting pattern applied at each cell is shown as a power spectral density (PSD) profile, specifically power spectral density as a function of physical resource block (PRB). This muting pattern could be in effect for a period of time. The throughput profile, throughput as a function of PRB, is also shown for each cell. The throughput profile can be derived from the actual served throughput, due to physical downlink shared channel (PDSCH), in the particular cell.

The throughput profile is indicative of the actual, as opposed to predictive, cell performance due to the muting pattern of the cell as well as the muting patterns of the neighbor cells. For example, in FIG. 1, PRB#3 in CELL-C can correspond to high throughput, because CELL-A and CELL-B are both muted in PRB#3 Similarly, PRB#1 in CELL-C can correspond to low throughput, because all the cells are transmitting with full power in PRB#1.

The throughput profile may be a useful metric for exchange in optimizing of muting patterns, because the profile lets the cell know the direct consequence of a certain muting pattern. The usage of the throughput profile can include adaptation of muting patterns in response to changing traffic and interference conditions. Interference conditions do not only depend on traffic but also on UE locations, especially if large antenna arrays are used for transmission.

For example CELL-A and CELL-B may interfere with each other for a large fraction of the PRBs or may not interfere with each other at all, depending on the user locations. The effects may be evident from exchanging throughput profiles.

As mentioned above, the throughput metric can be used to enable a closed-loop type of muting pattern adaptation unlike CSI and PF metrics for determining muting pattern. The throughput profile may also need to be associated with time-stamp information, considering the unpredictability of X2 delay.

Certain embodiments do not depend on the method of determination of the muting pattern or the architecture for coordination. In case of a distributed architecture, each cell can communicate the cell's own throughput profile to the neighboring cells. In the case of a centralized architecture, each cell can communicate the cell's own throughput profile to a centralized resource coordinator (CRC).

Definition of throughput profile and exchange of throughput profile can be standardized in specifications. The definition of a throughput profile can also be associated with a particular user group. For example, cell range extension UEs (CRE) can form a user group.

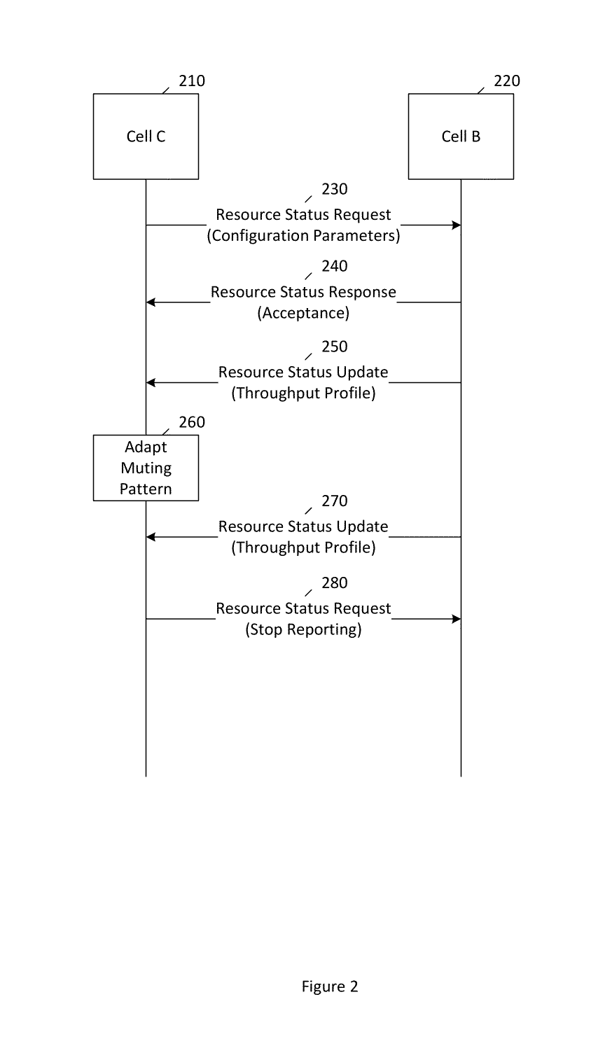

FIG. 2 illustrates a signal flow diagram according to certain embodiments. FIG. 2 shows an example embodiment for a distributed architecture. As shown in FIG. 2, at 230, Cell-C 210 can send a resource status request message to Cell-B 220, requesting Cell-B's throughput profile.

The request can optionally contain additional configuration parameters. Such configurations can be, for example, a request to indicate UE grouping, thresholds, reporting criteria, or the like. UE groupings can include, for example, CRE UEs only, 5-percentile UEs only, all UEs, or the like.

Then, at 240, Cell-B 220 can send a resource status request message to Cell-C 210, indicating acceptance of the request. At 250, Cell-B 220 can send a resource status update message to Cell-C 210 to convey a first throughput profile. Optionally, the first throughput profile can be included in the acceptance of the request or can serve as an indication that the request has been accepted.

The per-PRB throughput value could be represented in various ways. For example, the value can be represented as an average throughput value. For example, the value may be between 0 kbps and max kbps. Alternatively, the throughput value can be represented as a normalized throughput value. For example, the value can be between 0 and 100, high/med/low, or the like.

In another example, each PRB can be identified by its position in the list: the first element in the list can correspond to PRB 0, the second to PRB 1, and so on. A value of 0 can indicate 0 throughput, and a value of 100 can indicate maximum throughput. Throughput can be measured on a linear scale. Alternatively, the throughput can designated as high throughput, medium throughput, low throughput, or the like, with more or less granularity, as desired.

At 260, Cell-C 210, on receiving the information from Cell-B 220, can adapt the muting pattern of Cell-C 210. The adapting can also be based on receiving similar reports or other information from other cells.

At 270, Cell-B 220 can send additional resource status update messages whenever reporting criteria are met. The reporting criteria can be hard-coded or configurable in a resource status request or from operations and maintenance (OAM). Reporting criteria can include, for example, periodic or event-triggered. An event-triggered reporting criterion may be, for example, when muting pattern changes in at least one neighbor cell.

At 280, Cell-C 210 can send a resource status request message to Cell-B 220 to stop the throughput profile reporting. Alternatively, the resource status request message may include updated, new, or different reporting criteria.

The actual throughput measurement definition may be standardized or may be left to eNB implementation. For example, the definition could be based on the “Scheduled IP Throughput for MDT in DL” as defined in 3GPP TS 36.314, discussed above. Alternatively, the definition can be based on physical layer bits transmitted or the like.

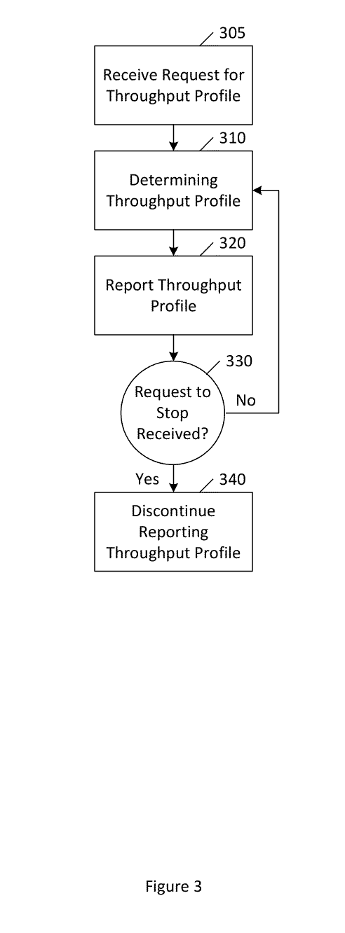

FIG. 3 illustrates a method according to certain embodiments. The method of FIG. 3 may be performed by a network element such as a base station. As shown in FIG. 3, a method can include, at 310, determining a throughput profile for a group of user equipment in a cell. The throughput profile can be determined as a function of physical resource block in frequency. Other functions are also permitted. The throughput profile can be conditioned on a muting pattern applied for a downlink shared channel in the neighbor cell. Thus, the throughput profile can reflect the impact that muting patterns of neighboring cells have on the cell providing the report.

The throughput profile can express a throughput value as at least one of an average throughput value or a normalized throughput value. Other ways of expressing throughput value are also permitted.

The method can also include, at 320, reporting the throughput profile to a neighbor cell or central node. The reporting can be, for example, at least one of periodic reporting or event-triggered reporting. Alternatively, the reporting can be one time reporting. The reporting can be contingent on a reporting criterion being met, such as a muting pattern changing.

The determining can be based on having received, at 305, a request for a throughput profile. After the throughput profile has been reported, at 330, the system can evaluate whether a request to stop reporting has been received. If so, then at 340, the system can discontinue reporting the throughput profile. Otherwise, the system can repeatedly determine and report the throughput profile, for example periodically, or whenever triggered by an event occurring.

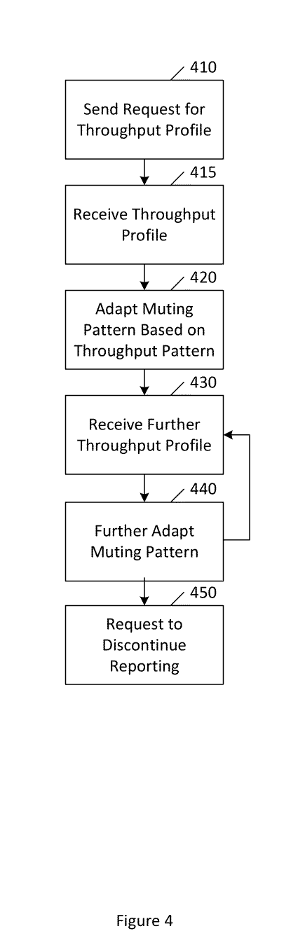

FIG. 4 illustrates another method according to certain embodiments. The method of FIG. 4 may be performed by a network element such as a base station or a central node. The method can include, at 410, sending a request for a throughput profile from a first cell. The first cell here may refer to a neighboring cell to a base station. The request can include a reporting criterion or more than one reporting criteria.

The method can also include, at 420, adapting a muting pattern of a second cell based on the throughput profile, when received at 415. The second cell here may be an own cell of the base station.

The method can additionally include, at 430, receiving a further throughput profile from the first cell based on the request. The method can additionally include, at 440, further adapting the muting pattern based on the further throughput profile.

The above process can repeat. However, if further reports are not desired, then at 450, the method can include sending a further request to the first cell to discontinue sending throughput profiles.

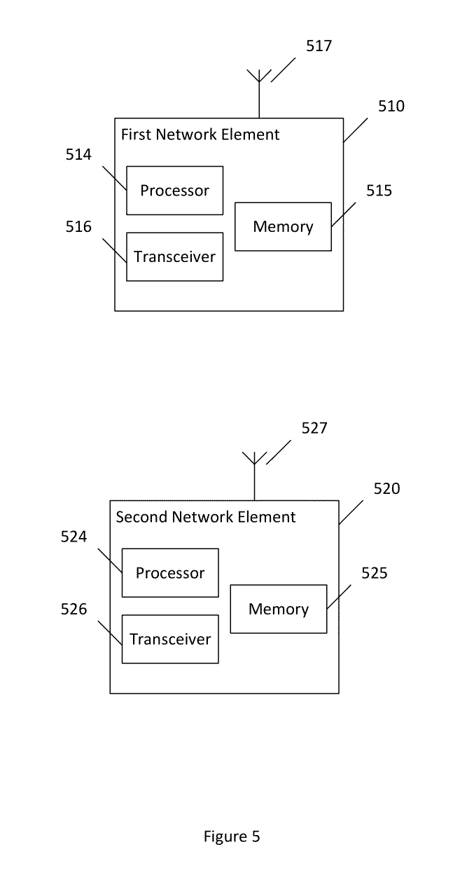

FIG. 5 illustrates a system according to certain embodiments. It should be understood that each block of the flowchart of FIG. 3 or 4 and any combination thereof may be implemented by various means or their combinations, such as hardware, software, firmware, one or more processors and/or circuitry. In one embodiment, a system may include several devices, such as, for example, first network element 510 and second network element 520. The system may include more than one second network element 520 and more than one first network element 510, although only one of each is shown for the purposes of illustration. A network element can be an access point, a base station, an eNode B (eNB), server, host or any of the other network elements discussed herein. For example, a network element can be a central network element in a centralized architecture.

Each of these devices may include at least one processor or control unit or module, respectively indicated as 514 and 524. At least one memory may be provided in each device, and indicated as 515 and 525, respectively. The memory may include computer program instructions or computer code contained therein. One or more transceiver 516 and 526 may be provided, and each device may also include an antenna, respectively illustrated as 517 and 527. Although only one antenna each is shown, many antennas and multiple antenna elements may be provided to each of the devices. Other configurations of these devices, for example, may be provided. For example, first network element 510 and second network element 520 may be additionally configured for wired communication, in addition to wireless communication, and in such a case antennas 517 and 527 may illustrate any form of communication hardware, without being limited to merely an antenna. Likewise, some network elements 510 may be solely configured for wired communication, and in such cases antenna 517 may illustrate any form of wired communication hardware, such as a network interface card.

Transceivers 516 and 526 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network element deliver local content. One or more functionalities may also be implemented as virtual application(s) in software that can run on a server.

In an exemplary embodiment, an apparatus, such as a base station or central node, may include means for carrying out embodiments described above in relation to FIG. 3 or 4.

Processors 514 and 524 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 515 and 525 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as first network element 510 and/or second network element 520, to perform any of the processes described above (see, for example, FIGS. 1 through 4). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 5 illustrates a system including a first network element 510 and a second network element 520, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node. The second network element 520 may likewise be provided with a variety of configurations for communication other than communication first network element 510. For example, the second network element 520 may be configured for device-to-device communication.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
determining a throughput profile for a group of user equipment in a cell; and
reporting the throughput profile to a neighbor cell or central node.

2. The method of claim 1, wherein the throughput profile is determined as a function of physical resource block in frequency.

3. The method of claim 1, wherein the throughput profile is conditioned on a muting pattern that is applied to one or more physical resource blocks carrying a downlink channel in a neighbor cell.

4. The method of claim 3, wherein the muting pattern comprises a set of transmission powers that includes zero power and corresponds to a downlink channel in a set of physical resource blocks.

5. The method of claim 1, wherein the reporting is at least one of periodic reporting or event-triggered reporting.

6. The method of claim 1, wherein the reporting is contingent on a reporting criterion being met, wherein the reporting criterion comprises a muting pattern changing.

7. A method, comprising:
sending a request for a throughput profile from a first cell; and
adapting a muting pattern of a second cell based on the throughput profile.

8. The method of 7, further comprising:
receiving a further throughput profile from the first cell based on the request; and
further adapting the muting pattern based on the further throughput profile.

9. The method of claim 7, further comprising:
sending a further request to the first cell to discontinue sending throughput profiles.

10. The method of claim 7, further comprising:
including a reporting criterion in the request.

11. An apparatus, comprising:
at least one processor; and
at least one memory including computer program code,
wherein the at least memory and the computer program code are configured to, with the at least one processor, cause the apparatus at least to
determine a throughput profile for a group of user equipment in a cell; and
report the throughput profile to a neighbor cell or central node.

12. The apparatus of claim 11, wherein the throughput profile is determined as a function of physical resource block in frequency.

13. The apparatus of claim 11, wherein the throughput profile is conditioned on a muting pattern that is applied to one or more physical resource blocks carrying a downlink channel in a neighbor cell.

14. The apparatus of claim 13, wherein the muting pattern comprises a set of transmission powers that includes zero power and corresponds to a downlink channel in a set of physical resource blocks.

15. The apparatus of claim 11, wherein the reporting is at least one of periodic reporting or event-triggered reporting.

16. The apparatus of claim 11, wherein the reporting is contingent on a reporting criterion being met, wherein the reporting criterion comprises a muting pattern changing.

17. An apparatus, comprising:
at least one processor; and
at least one memory including computer program code,
wherein the at least memory and the computer program code are configured to, with the at least one processor, cause the apparatus at least to
send a request for a throughput profile from a first cell; and
adapt a muting pattern of a second cell based on the throughput profile.

18. The apparatus of 17, wherein the at least memory and the computer program code are configured to, with the at least one processor, cause the apparatus at least to
receive a further throughput profile from the first cell based on the request; and
further adapt the muting pattern based on the further throughput profile.

19. The apparatus of claim 17, wherein the at least memory and the computer program code are configured to, with the at least one processor, cause the apparatus at least to send a further request to the first cell to discontinue sending throughput profiles.

20. The apparatus of claim 17, wherein the at least memory and the computer program code are configured to, with the at least one processor, cause the apparatus at least to include a reporting criterion in the request.
